(19) United States
(12) Patent Application Publication
(10) Pub. No.: US 2026/0355885 A1
(43) Pub. Date: Nov. 12, 2026

(54) Gantry-type machining centre for machining elongated wood pieces

(71) Applicant: Essetre S.r.I. Unipersonale, Thiene (IV) (IT)

(72) Inventor: Nicola Sella, Thiene(VI) (IT)

(21) Appl. No.: 19/139,207

(22) PCT Filed: Dec. 11, 2023
(86) PCT No.: PCT/IB2023/062498

§ 371 Date: Jun. 13, 2025

(30) Foreign Application Priority Data
Dec. 20, 2022 (IT) 102022000026076

(51) Int. Cl. B23Q 7/04; B27B 5/20; B27B 31/00

(52) U.S. Cl. CPC B23Q 7/042; B27B 5/207; B27B 31/003; B23Q 2240/007

(57) ABSTRACT

A gantry-type machining center for processing wood pieces having a predominantly longitudinal extension includes an infeed way for a workpiece to be machined, an unloading way for the machined workpiece, a working station having an inlet and an outlet and a supporting frame of a work tool, the working station is interposed between the loading way and the unloading way. Grippers are associated with the loading and unloading ways for loading and unloading a wood piece, of which a first gripper can move along a distal and a proximal end of the loading way, in the feed direction of the workpiece, and a second gripper can move in the feed direction of the workpiece within the working station, forward and backward, between the inlet and the outlet of the workpiece, an unloading grabber being provided at least at the outlet of the working station.

It is an object of the present invention to have a gantry-type machining center for machining wood pieces having predominantly longitudinal extension, such as beams, boards or the like, which machining center includes:
a loading way for at least one workpiece,
an unloading way for the workpiece,
a working station having an inlet and an outlet on opposite sides of said station, and comprising a supporting frame of at least one working tool, said working station being interposed between said loading way and said unloading way, said loading way ending at said inlet of said working station and said unloading way starting at said outlet of said working station;
to said ways of loading and unloading being associated corresponding grippers of loading and unloading of said piece.

Optionally, below the plane defined by the loading and unloading ways and coinciding with the working station, i.e., below the machining tool, a unit for collecting and transporting machining scraps outside the working station may be provided.

According to the known art, described, for example, in document IT102011901997732, the grippers associated with the loading and unloading ways are translatable parallel to the path defined by the corresponding loading or unloading way and terminate their travel at the inlet and outlet from the working station.

Within this working station, the workpiece overhangs the end of the corresponding loading or unloading way and is held fixed by means of the corresponding gripper.

Therefore, in the case of machining, for example, on both the front and rear ends of a beam, board, or the like, it is first held cantilevered by its front end (with reference to the loading and unloading defection) by the gripper associated with the loading or unloading way and then advanced beyond the station to the entrance of the unloading way where it is grasped by the gripper associated with the said unloading way and advanced further to the position where, for example, the rear end is not in the tool's working area. Thus, in this position, the end section or tail of the workpiece protrudes cantilevered into the working station and the workpiece is firmly held in place by the gripper associated with the discharge pathway.

This construction is effective when the lengths of the workpiece are greater to some extent than the size of the working station between the inlet and outlet. However, even in these cases they require for workpiece load that one or both grippers perform repositioning operations with respect to the workpiece that allow the front end of the workpiece to be brought beyond the exit of the working station and for a certain extent into the initial section of the unloading way and thus into the area where the gripper associated with the said unloading way can safely and firmly enough grasp the front end of the workpiece that has been pushed beyond the working station by the gripper associated with the loading way.

When the workpiece is to be cut or already has a length less than the distance between entry and exit from the machining station, it is impossible to hold the workpiece the machining of the rear end of the workpiece, with reference to the direction of feed in the working station itself.

Therefore, there is a need to provide for improved machining centers that allow for better handling of workpieces, and which can also provide for use in combination with workpieces having a relatively short length and even less than the size of the area defined by the working station in the direction of feed of the workpiece between entering the working station and leaving the working station.

Accordingly, the invention relates to a gantry work center for machining wood pieces having predominantly longitudinal extension, such as beams, boards or the like, which work center comprises:
a loading way, for at least one workpiece to be machined,
an unloading way, for the workpiece being machined,
a working station having an inlet and an outlet on opposite sides of said station, and comprising a supporting frame of at least one working tool, said working station being interposed between said loading way and said unloading way, said loading way ending at said inlet of said working station and said unloading way starting at said outlet of said working station;
to said ways of loading and unloading being associated corresponding grippers of loading and unloading of said piece, and wherein,
a first gripper is provided movable along the loading way, in a moving direction of the workpiece, between a distal end from the working station and a proximal end to the working station,
while a second gripper is provided movable in the moving direction of the workpiece, forwards and backwards, within the working station, between the inlet and the outlet of the workpiece from the working station,
and while an unloading gripper is provided at least in correspondence, preferably directly adjacent to the outlet from the working station.

According to an executive form, in the machining centre a working area of at least a working tool is provided at the working station, said working area comprising a part of the space volume inside said working station, said working area is three-dimensional and consists of a vertical column having a pre-established dimension in the moving direction of the workpiece and in the transverse direction to said moving direction of the workpiece as well as a pre-established vertical extension between two horizontal levels, respectively, a minimum lower level and a maximum upper level, while between the vertical side wall(s) delimiting said volume of space inside said working station and the corresponding virtual limits of the working area of said at least one working tool there is provided a moving corridor for said second gripper of said workpiece provided inside said working station, which corridor constitutes a non-interference zone between said second gripper and said at least one working tool, said second gripper and said at least one working tool being freely movable within the respective working area and moving corridor.

According to an improvement, the working area of said at least one working tool and the moving corridor of said second gripper within the working station are placeable relatively to each other according to the intended working position of said at least one working tool and/or the intended working position of said second gripper, safety limits being provided consisting of the distance and/or the minimum possible size respectively between said at least one working tool and said second gripper and/or for the said working area of said at least one working tool and for the moving corridor of said second gripper.

According to an embodiment, the working tool is supported by a motorised moving member according to at least two, in particular three, preferably five or more degrees of freedom of said working tool, said second gripper comprising motorised gripping members and it is supported by a moving member thereof enabling displacement of said second gripper, said moving member being controlled by a control logic comprising a central processing unit executing a control program which comprises instructions for synchronised displacement and activation and deactivation of said at least one working tool and of said second gripper and in which relative dimensions and positions between said working area of said at least one working tool and said moving corridor of said second gripper are settable.

Different configurations of the above-mentioned moving member of said at least one tool and/or the said second gripper are possible.

One possible executive form is the use of robotic arms as the moving members of said at least one tool and/or said second gripper.

Such a solution although technically possible is also expensive in view of the machining operations that are typically performed in machining centers of the said type.

According to a preferred embodiment, said second gripper is mounted on a motorised slide which is slidable on a guideway oriented parallel to the moving direction of the workpiece and is translatable in a direction concordant or discordant to the moving direction of the workpiece.

Optionally, the gripper can be mounted on the said horizontal slide by means of an additional combination of vertical guides and slide sliding on the same and allowing the gripper to be translated upward and downward.

According to yet another feature, a combination of slides can also be provided for the said at least one working tool.

Advantageously, an embodiment provides that the movable member of the said at least one working tool comprise a combination of guides and related slides in which at least two guides with related slides or related carriages are provided, and which guides are oriented at least in a direction transverse to the direction of feed of the workpiece and at least according to a vertical direction.

Advantageously, a preferred embodiment provides that the said at least one tool is mounted rotatable about at least one axis parallel to one of said at least two mutually orthogonal guideways and/or according to an axis of oscillation or tilting perpendicular to said axis of rotation.

With reference to yet another feature of the work center according to the present invention, the first gripper associated with the loading way of the workpiece, consists of a gripper hereafter also referred to as a load gripper, which gripper has at least two gripper jaws that can be approached and spaced between an open position in which the workpiece is free to move relative to the gripper in a closed position in which said jaws clamp opposing sides of the workpiece between them, holding it fixedly between them, while said two jaws have extensions in front of and/or parallel to the direction of the workpiece's advance toward the working station, which extensions extend toward the area of the working station entrance, beyond the end position of maximum approach of said loading clamp to the working station entrance for the workpiece or part thereof.

According to one embodiment, the second gripper inside the working station also comprises a gripper having a pair of clamping jaws, at least one of which is movable relative to the other.

At said inlet the working station has at least one pair of opposing rollers for gripping the workpiece to be machined at the inlet to said working station, the rollers) of which pair are rotatable about axes which are parallel to each other, said rollers or at least one of said rollers being displaceable transversally to the rotation axis in the direction of reciprocal approach and distancing and to and from the side of the workpiece respectively facing one of the two rollers.

One embodiment provides in combination a second pair of rollers which are rotatable about axes parallel to each other and mounted displaceable in the direction of reciprocal approach and distancing and to and from the corresponding side facing the respective roller of the workpiece, the axes of said further pair of rollers being oriented according to a different direction with respect to the axes of said first pair of rollers, in particular according to a direction perpendicular to the axes of said first pair of rollers, and the direction of approach and departure of the rollers of said first pair of rollers also being different and preferably perpendicular to the direction of reciprocal approach and departure of said first pair of rollers.

In an executive form, the first pair of rollers has vertical axes of rotation and is movable in the direction of mutual approach and departure parallel to the horizontal direction, while the axes of the second pair of rollers are horizontal and the direction of mutual approach and departure of these rollers is vertical.

In combination with at least the said first pair of rollers and/or the two pairs of rollers, the front jaw extensions from the first gripper, i.e., the loading gripper terminate at or in a position immediately adjacent to the plane of axle displacement of the said first pair of rollers, when the loading gripper is in the end position of maximum approach to the entrance of the working station.

An execution variant provides that one of the two rollers of the second pair of rollers, is stationary and extends with its mantle surface flush with the workpiece support plane of the loading way.

According to yet another refinement feature, one of the two rollers of the first pair of rollers, or the pair of rollers with vertical axes, is stationary and it is a workpiece reference stop position, also referred to as zero reference, while the rollers have an axial extension which is greater than the corresponding maximum dimension of the workpiece being machined, which axial extension is greater than the corresponding maximum dimension of the workpiece being machined corresponding to the sum of the dimensions in said direction of the front extensions of the jaws and/or of at least part of the stroke in the direction of reciprocal displacement of said jaws, and while in the position of maximum approach of the loading gripper to the inlet of the working station, said jaw extensions of the jaws of the loading gripper overlap with the side of the stationary roller on the side facing the opposing roller of said first pair of rollers, at least for part of the diameter of said roller or for the entire diameter of said roller in the moving direction of the workpiece.

According to still a further feature, the second gripper inside the working station is slidable in the two directions between the inlet and the outlet of the working station along a guide oriented in the moving direction of the workpiece and optionally preferably aligned, as an extension in said moving direction of the workpiece or realised in one piece with the traversing guide of the first gripper associated with the loading way, while in the position of maximum approach to the inlet of the working station said second gripper is directly adjacent to the facing ends of the front extensions of the jaws of the loading gripper, constituting an extension thereof in the moving direction of the workpiece.

Similarly to the first gripper associated with the loading way, the second gripper is mounted on a motorized slide or carriage and its jaws are actuated by motorized actuator alternately in the direction of approaching and receding, that is, in the direction of clamping opposing sides of the workpiece and distancing or freeing the workpiece.

On the exit side of the working station, the second gripper is positioned adjacent to a pair of grippers, e.g., motorized, counter-rotating unloading rollers which are movable relatively to each other in the direction of mutual approach and departure and to and from facing mutually opposite sides of the workpiece and which are actuated for extracting the workpiece from the working station when the second gripper has been brought into a workpiece free condition.

According to yet another feature, the stationary roller of the first pair of rollers, at the inlet of the working station is associated, in a spaced position to a certain extent towards the loading way at least one further stationary roller which is aligned with the stationary roller of the first pair of rollers relative to the feed direction of the workpiece towards the working station, is rotatable about an axis parallel to that of the rollers of said first pair of rollers, and has a diameter identical to said stationary roller of said first pair of rollers, thereby generating with it two support points which are spaced apart from each other in the moving direction of said workpiece and which define the reference position of said workpiece relative to the direction perpendicular to the moving direction of said workpiece and parallel to the support plane of said workpiece on the loading way and on the bottom roller of said second pair of rollers.

According to an embodiment of the present invention, the control computer of the working station executes a control program which comprises instructions for said computer to control the process of manipulating the workpiece by means of the two grippers according to the following steps:
the first gripper associated with the loading way grips the workpiece being processed by moving to the position of maximum approach to the inlet of the working station;
in this position it finds the second gripper inside the working station which has been brought to the position directly adjacent to the inlet of the working station and to the ends of the extensions of the jaws of the first loading gripper;
the second gripper clamps the workpiece being machined, leaving an initial section projecting forward with respect to the gripper itself, and the first gripper opens by releasing it while the second gripper moves relative to the working tool to the right and/or left of the same to perform a machining operation that defines a reference relative to the longitudinal extension of the workpiece, typically a cut
at least the second gripper or both grippers remain active or are activated to clamp the workpiece to be machined after the zero cut and the second gripper with the workpiece clamped in it and optionally also the first gripper move in the direction of the workpiece move until the second gripper has passed beyond the working range of the tool of the workpiece and at a further predefined machining zone of the workpiece, in particular the tail, i.e. the rear end of the workpiece;
at least the second gripper moves further towards the outlet of the working station with the workpiece clamped therein until it is gripped by the unloading grippers which pick up the workpiece and deposit it on the unloading way after the second gripper has passed in an open condition and thus released the workpiece itself.

In an executive form, the working station includes at least one tool that consists of a workpiece cutting tool.

In a further executive form, the working station may comprise at least two or more machining tools, at least one of which consists of a cutting tool.

These and other features and advantages of the present invention will become clearer from the following description of some of the execution examples illustrated in the accompanying drawings in which:

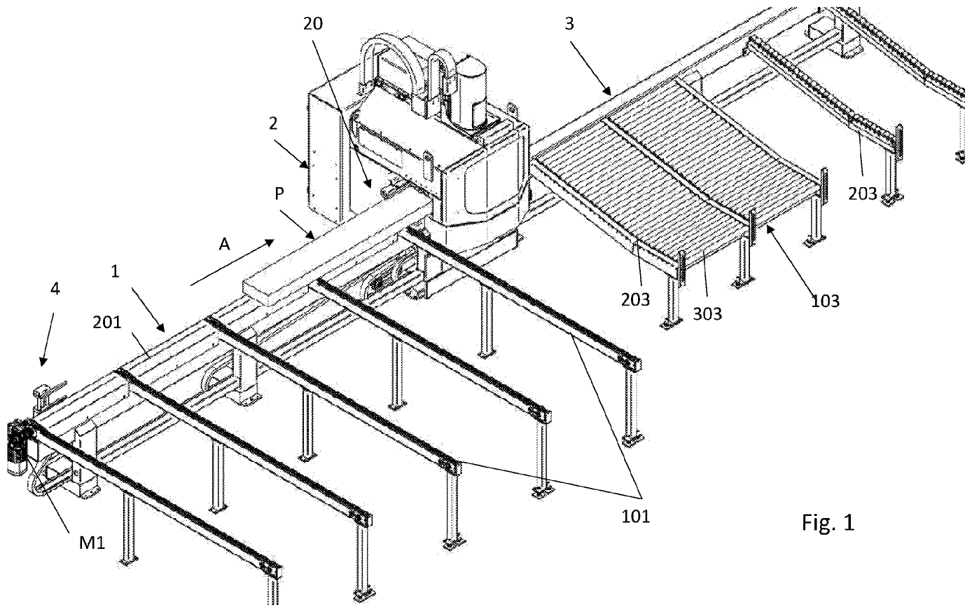

FIG. 1 is a perspective view of a machining center according to an embodiment of the present invention, particularly a center for cutting beams, boards, or the like.

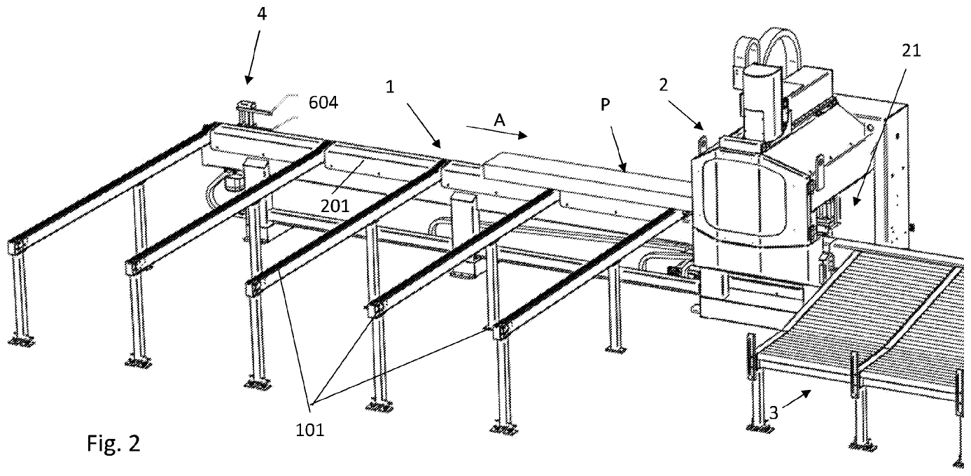

FIG. 2 is a perspective view of the machining center according to FIG. 1 from an opposite direction of view.

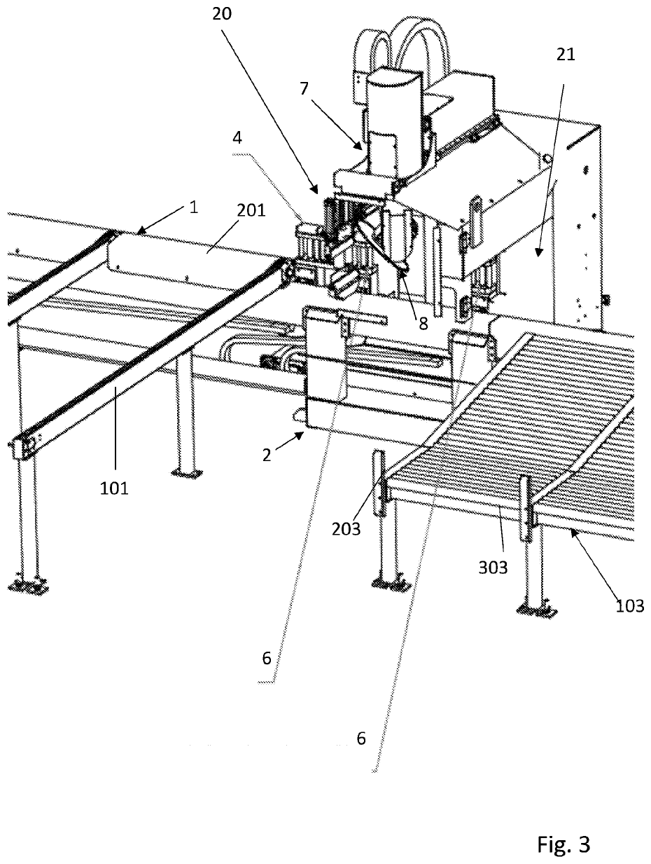

FIG. 3 is an enlarged view of the working station in FIG. 2 in a perspective view from a similar direction of view as FIG. 2.

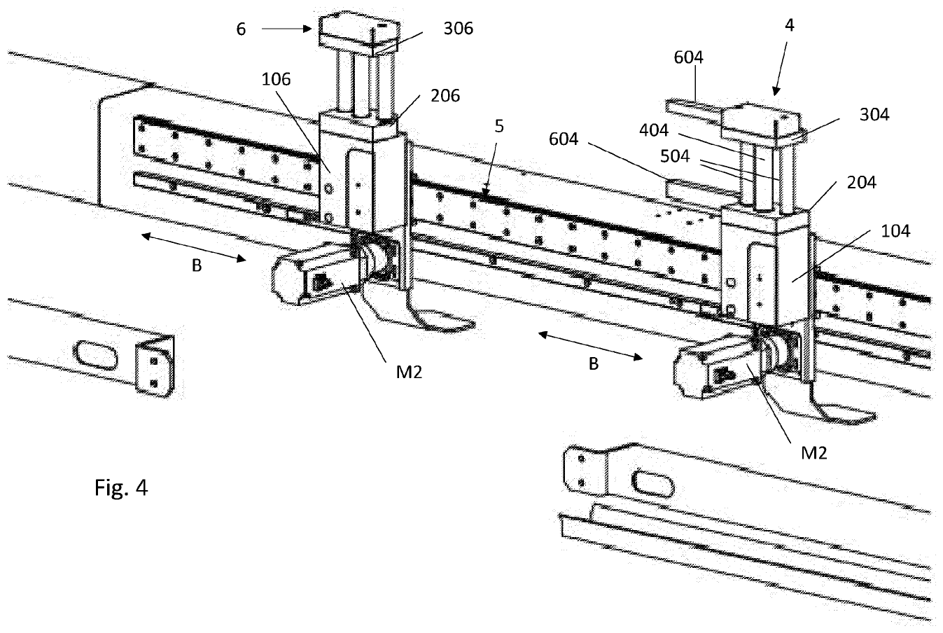

FIG. 4 shows a perspective view on the translation guide in the direction of workpiece loading and on the first gripper, i.e., the loading gripper, and on the second gripper, i.e., the gripper inside the machining station being the other construction parts omitted.

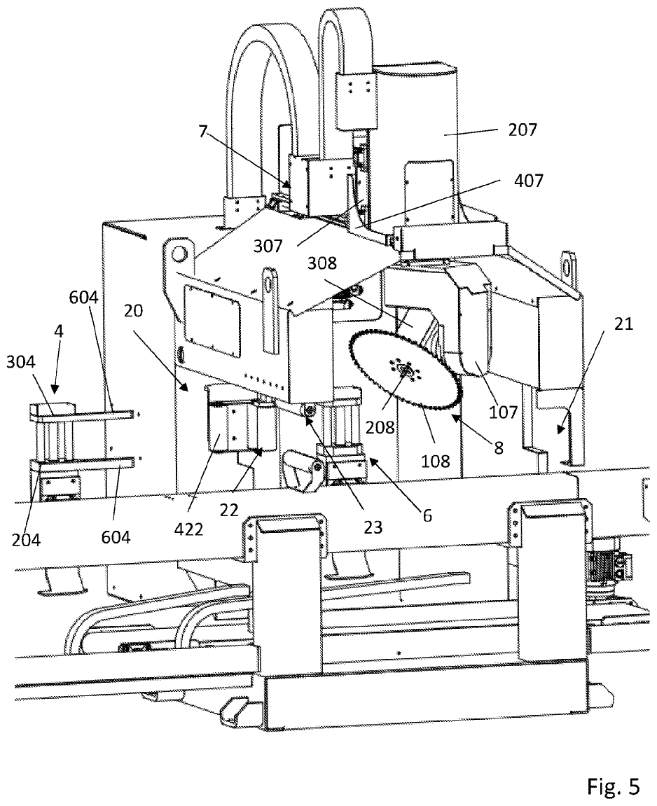

FIG. 5 shows an enlarged view of the machining station area according to yet another direction of view having a component in the laoding direction of the workpiece and with the first gripper loading and the second gripper in a working position.

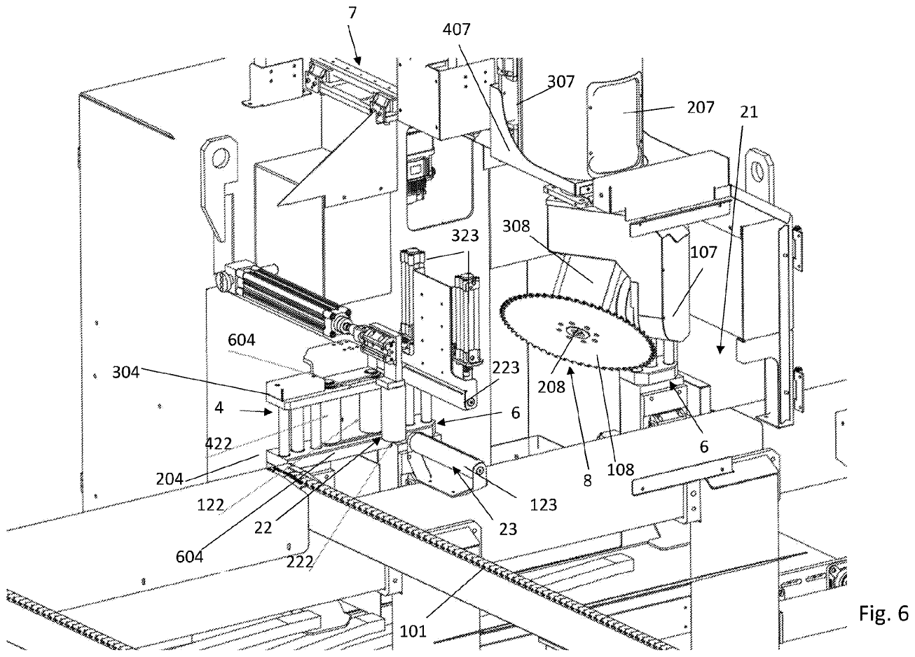

FIG. 6 is a perspective, enlarged view of the working station relative to the area of the inlet and opposite outlet of the workpiece from said working station and with the first gripper, i.e., the loading gripper at the end position of maximum approach to the inlet of the working station and the second gripper inside the working station in a position directly adjacent to the said first gripper for picking up the workpiece from the said first loading gripper and the loading way.

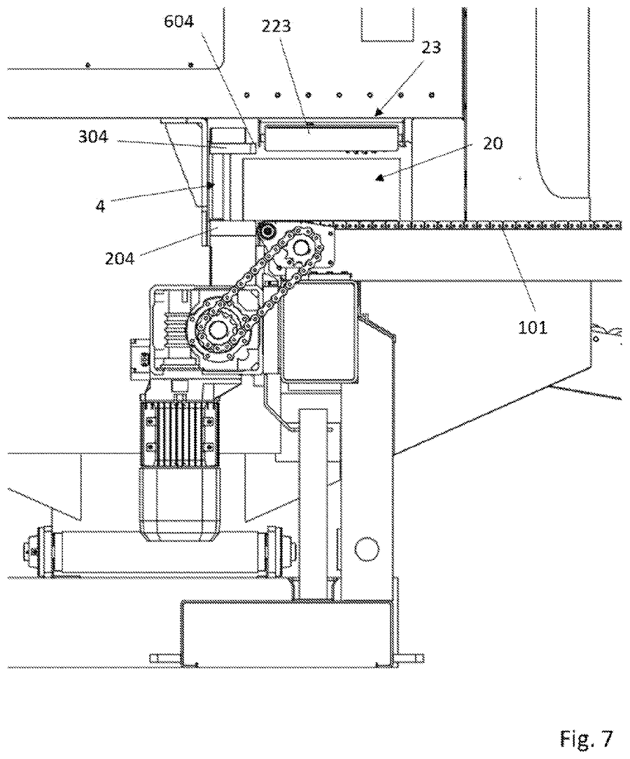

FIG. 7 shows a side elevation view on the inlet side of the working station and in the direction of view parallel to the workpiece loading direction.

Referring, in particular, to FIGS. 1 to 3, a machining center for machining wood workpieces, having a predominantly longitudinal dimension, i.e., a direction parallel to the direction of advancement of said workpiece, such as beams, boards, or the like comprises a loading way 1 of at least one workpiece P or a succession of workpieces P to be machined for loading said workpiece P or said workpieces P to a machining station 2. Said loading way 1 is located upstream of said machining station 2.—with reference to the direction of loading of said workpieces P to be machined-and ends at an inlet 20 of said machining station 2. Downstream of said machining station 2 and in a position directly adjacent to an outlet 21 of said machining station is provided an downloading way 3 of the machined workpieces being transported out of said machining station 2 through said outlet.

It is worth considering here that the specific configuration described and illustrated in the illustrated example of the loading ways and the processing station are not to be regarded as limiting the protective scope, and the said units or other constituent parts of the work center according to the invention can also be realized in a different way without abandoning the inventive teaching, it being clear from the preceding introductory description which features are essential to the present invention and which are also reproduced in the illustrated example, and which features, on the other hand, can be modified according to a: plurality of different constructive variants that are part of the basic technical cultural background of the expert in the branch and from which the said expert can choose on the basis of expediency without thereby performing inventive activities.

Specifically, as a loading way, the example shows a loading conveyor operating by transferring to a predetermined pick-up position one workpiece at a time by means of a translation of said workpiece, preferably parallel to itself, in a direction transverse to the longitudinal extension of said workpiece and the longitudinal axis of the workpiece being positioned parallel to the direction of loading to the processing station.

A plurality of conveyor belts 101 that are arranged parallel to each other and interspaced in the loading direction of the workpiece P to be machined toward working station 2 and in said working station 2, are oriented perpendicular to said loading direction (arrow A in FIG. 1). The belts are returned around end pulleys of which at least one of said two opposite pulleys is rotationally driven by an MI motor. In particular as shown in the figure and by way of example only, but not limitation all belts are driven by a single motor by means of a common axis of rotation extending along all the deflection pulleys of the individual belts 101 provided at the ends of the belts whose ends coincide with or fall in the area of the position of picking up the workpiece P for loading it to the working station 2.

In lieu of belts, it is possible to provide tapes or chains or other elongated elements closed in on themselves which have an upper supporting branch of the workpiece P to be worked on and a lower returning branch and which have dragging organs or a coefficient of friction such that they grip the surfaces supporting the workpieces P on them in order to allow them to be dragged sideways.

At least one loading gripper 4 is associated with the loading way and is expected to be positioned or positionable at the workpiece P to be machined on the pick-up zone of the loading way. The pick-up zone denoted by 201 consists of a sliding surface oriented in the direction of feed of the workpiece P toward the working station 2 or parallel to the longitudinal extension of the workpiece(s) P to be machined.

The loading gripper 4 is mounted sliding on a translation guide 5 that is oriented parallel to the direction of loading A, i.e., the longitudinal extension of the workpiece(s) P to be machined, and extends laterally to said pre-picking zone or strip 201, while constituting a transverse traversing end stop of the individual workpieces P being transferred to the pre-picking zone or strip 201.

The loading gripper 4 is mounted on a slide or motorized carriage 104 M2 that is engaged sliding along the guide 5 in the two directions, i.e., forward and backward according to arrow B in the FIG. 4. The gripper 4 has a stationary lower jaw 204 that is intended to be positioned flush with the workpiece support surface P in the pick-up area 201 and an upper jaw 304 that is vertically movable in both directions, i.e., away from and toward the stationary lower jaw 104. The upper jaw is substantially vertically coincident with the lower jaw and is positioned by at least one vertical stem of a linear actuator, preferably, for example, by a combination of a stem 404 of a linear actuator and two vertical guides 504 parallel to themselves and to the stem 404. Said two guides may possibly constitute the end stops of the transverse transfer stroke of the individual parts P in the pick-up zone 201.

In the form of execution illustrated, the jaws 204 and 304 extend in the transverse direction with respect to the direction of loading A to a certain extent so as to form opposing clamping surfaces of the workpiece P that are intended to cooperate with a coincident part of one side of the workpiece P facing the corresponding jaw 204, 304, i.e., of two opposite sides of the workpiece P to be machined.

According to yet another feature that will be described in more detail below, on the end facing in the loading direction A of the workpiece the two jaws 204 and 304 each have an extension 604 that is intended to increase the contact surface between the jaw and the side correspondingly facing it by extending it further along the workpiece P in the longitudinal direction of the same and in the loading direction A.

As will become clearer below, and with particular reference to FIG. 4, an additional workpiece gripper 6 is provided within working station 2, which gripper 6 has a construction substantially similar to that of gripper 4, except for the absence of the extensions 604 of the corresponding jaws 206 and 306.

The second gripper 6 is slidably mounted on a guide which is oriented in the direction of loading A of the workpiece and which is an extension of the guide 5 of the first gripper 4 or is longitudinally aligned with the same or which, as illustrated in FIG. 4, is formed by the same sliding guide 5 which also extends inside the working station 2 for a certain extent or for the entire extension of the compartment of the working station 2 between the inlet and the outlet of said working station 2.

An unloading way 3 is provided at the outlet of the working station 2, which can be realised in any way according to the variants and forms of execution known to the branch technician from his technical background. In the illustrated example, there is an inclined conveyor plane 103 comprising individual supports 203 or belts or sliding walls 303 provided between said supports and onto which the workpieces P are transferred by a pick-up and unloading device provided at the exit of the working station 2. Once the workpiece P after having been machined has been extracted from the working station by said organs, the same workpiece is positioned at the upper end of the inclined plane which constitutes the downloading way and whose upper end is contemplated to coincide with the inlet opening of the working station 2 with reference to the loading direction A. The machined workpiece P slides by the action of gravity alone or, if necessary, by conveyors associated with said inclined plane, such as belts or the like similar to those of loading route 1 towards a collection station, not shown in detail at the lower end of said inclined plane.

As is best evident from FIGS. 3, 5 and 6, there is provided in the working station an assembly 7 for supporting and handling at least one machining assembly 8. In the illustrated embodiment, the machining tool comprises the cutting disc of a circular saw, which cutting disc 108 is mounted on a shaft 208 of a drive motor 308. The drive motor 308 is driven in an oscillating manner about a horizontal axis by an end arm 107 of the support and handling assembly 7. The end arm 107 is in turn posted by a vertical shaft not shown in detail which is mounted rotatably about its vertical axis in a pivoting support indicated with 207, which specifically is of the column type. Said column support is mounted on a vertical guide and carriage or slide assembly indicated globally by 307 and said vertical guide 307 is in turn mounted on a slide or carriage sliding on a guide 407 horizontal and transverse to the loading direction A of the workpiece P in the working station 2.

Despite the fact that this is not illustrated in the example shown and described, it is possible to envisage that the cutting tool 108, i.e. the motor and tool assembly 108, 208 is additionally mounted on combinations of guides and slides or rotary supports for performing movements according to further axes or degrees of freedom.

Various execution variants are known and possible for the support and movement assembly 7 of the cutting tool 108 and form part of the basic technical background of the expert in the branch, who also in this case can choose from the various known execution forms without taking any inventive steps.

With reference to the figures, in particular FIGS. 1 and 2 show the first gripper 4 associated with the loading way 1 in its extreme position of maximum distance from the inlet 20 of the working station 2.

FIG. 3 shows said loading gripper 4 in the position of maximum approach to inlet 20 of said working station 2, while in the same FIG. 3, said second gripper 6 inside said working station 2 is positioned in the end position adjacent to outlet 21 of said working station 2.

FIG. 6 shows said two grippers 4, 6, respectively loading and internal to working station 2 in end-stroke positions similar to those shown in FIG. 3, while FIG. 5 shows said grippers in intermediate positions between the two extreme positions of said grippers. In particular, while in FIG. 5 the second gripper 6 internal to the working station 2 is positioned between the inlet 20 of said station and the tool 108, in FIG. 6 said second gripper 6 is positioned between the tool 108 and the outlet 21 of said working station 2.

FIG. 7 shows gripper 4 in the position of FIGS. 3 and 6, while gripper 6 is not visible as it is covered by this first gripper 4 with which it is perfectly aligned in loading direction A.

According to yet another feature, at the inlet 20 of the working station 2, there is a side stop of the workpiece which defines a fixed reference position, also called zero reference, of the workpiece P, with reference to a horizontal direction and perpendicular to the loading direction A or to the longitudinal extension of the workpiece P. Said stop is constituted by a stationary roller 122 having a vertical axis of rotation and a predetermined diameter, said stationary roller 122 being part of a pair 22 of rollers 122, 222 each of which is intended to cooperate with a side of two opposite sides of the workpiece P.

The second roller 22 of the pair is substantially identical to the first roller and is supported coincident with said first roller 122 in a direction perpendicular to the direction of advancement A and horizontal and furthermore translatable in said direction alternately approaching or receding the stationary roller 122 thanks to a translation support controlled by an actuator 322. The second roller 222 of the pair of rollers 22 is also rotatable about its axis. In the presence of the workpiece P, the second roller 222 is traversed against the facing side of the workpiece P and the workpiece P is slidingly confined longitudinally, i.e. in the lading direction A, between the two rollers by the action of the first gripper 4 and/or the second gripper 6 as will be described in greater detail below.

The first stationary roller 122 can be associated in a position aligned and parallel to said first stationary roller 122 by a certain pre-established distance and which constitutes a second lateral reference stop surface of the workpiece P, thanks to which a better support of said workpiece P on the position references is ensured.

As can be seen from the figures, a second pair of rollers 23 is provided directly downstream of said first pair of rollers 22. In this case, the rollers 123 and 223 of said second pair of rollers 23 are oriented with their axes in a horizontal position and perpendicular to the feed direction A and are vertically coincident with each other both with their axes and with their mantle surfaces, having the same diameter.

In accordance with an embodiment, the lower horizontal roller 123 is stationary and its mantle surface extends flush with the support plane of the pick-up area of the loading way 1, while the upper roller 223 is mounted translatably, parallel to itself and in the vertical plane containing the axes of the two rollers 123 and 223, upwards and downwards in the direction of approach or departure from the stationary horizontal roller 123 and against the facing side of the workpiece P when it is inserted at least with one of its sections within the working station 2. The horizontal upper roller 223 is moved by actuators 323.

Therefore, when the workpiece P is brought in at the inlet 20 of the station 2, the two pairs of vertical and horizontal rollers 22 and 23 ensure that the workpiece is kept in the precise position with respect to stationary references in both vertical and horizontal directions.

As is particularly evident from FIG. 6, the vertical axial extension of the rollers 122 and 222, but possibly also of the roller 422 when present as in this case, is greater than the distance between the outer walls of the two opposite jaws 294 and 304 of the first gripper, 4 i.e. of the loading gripper and the corresponding front extensions 604, and the length of said front extensions is substantially corresponding to the distance of two diametrically opposed points of the shell surfaces of said two stationary rollers 122 and 422, or to the distance corresponding to the distance of the axes of said rollers plus a diameter of said rollers, and the position of said extensions in a horizontal direction and perpendicular to the direction of advancement is defined in such a way that said extensions overlap laterally with said rollers 422 and 122 on the side of said rollers facing the opposite roller 222. This makes it possible to keep the gripper 4 clamped against the workpiece p even when the workpiece is brought with its front end at said inlet 20. The second gripper 6 inside the machining station 2 can be brought in this case to the position directly adjacent to the pair 22 of rollers and the front ends of the front extensions 604 of the gripper 4, as is evident from FIG. 6.

Thanks to this combination, a workpiece P entering the working station 2 can be gripped by the first gripper 4 and brought to engage with its front end in the second gripper 6. The latter, after having grasped the workpiece P in a predetermined position with respect to the protruding end beyond the same of the workpiece P, can advance towards the zone of action of the tool 108 while remaining outside of it, but bringing said end into the zone of action of the tool 108. It is thus possible to perform an initial reference cut, for example, in the present case, to measure the length of workpiece P.

After said cut has been made, said two collets 4 and 6 can be actuated synchronously with each other to move said workpiece P forward together or alone, in a measure corresponding to a new machining position and to the final machining step to bring the tail of said workpiece P into the zone of action of the tool 108 to perform the machining steps of said tail of said workpiece P.

Thanks to this second gripper 6, the workpiece can always be firmly held in position by the second gripper, which can be brought as close as possible to the boundaries of the field of action of the tool P while remaining outside said field of action and thus effectively and safely avoiding interference between the tool 108 and the inner gripper 6.

At the end of the machining process, depending on the length of the workpiece P. a part of the workpiece is already engaged with a workpiece extraction unit from said working station or is brought into an engaged condition with said unit by the second collet 6.

In the illustrated example, said extraction unit is not visible in detail, but may, for example, be constituted by a pair of driving rollers which are brought to cooperate with opposite sides of said workpiece P and which, thanks to friction surfaces increased between them and said surfaces of said workpiece P and being driven in rotation by a motor, provide for the advancement of said machined workpiece P out of said station 2 bringing it to the unloading way 3, for example on the upper side of the inclined plane forming said unloading way.

In an executive form, the inner gripper 6 occupies a part of the workpiece with an extension in the longitudinal direction of approximately a couple of tens of centimetres, e.g. between 15 and 25 cm.

The invention claimed is:

1. A machining center of gantry-type for machining wood pieces having a predominantly longitudinal extension, comprising:
a loading way (1) for a workpiece (P) to be machined;
an unloading way (3) for the machined workpiece (P);
a working station (2) having an inlet (20) and an outlet (21) on opposite sides of said working station, and comprising a supporting frame of a working tool (8, 108), said working station (2) being interposed between said loading way (1) and said unloading way (3), said loading way (1) ending at said inlet (20) of said working station (2) and said unloading way (3) starting at said outlet (21) of said working station (2) ;
grippers (4, 6) of loading and respectively unloading of said workpiece (P) associated to the loading way and respectively the unloading way, of which:
a first gripper (4) is movable (5) along the loading way, in a moving direction (A) of the workpiece (P), between a distal end from the working station (2) and a proximal end to the working station (2),
a second gripper (6) is movable in the moving direction (A) of the workpiece (P), forwards and backwards, within the working station (2), between the inlet (20) and the outlet (21) of the working station (2), and
an unloading gripper is provided adjacently to the outlet (21) of the working station (2).

2. The machining center according to claim 1, further comprising a working area of a working tool (8, 108) at the working station (2), said working area comprising a part of a space volume inside said working station (2), said working area is being three-dimensional and comprising a vertical column having a pre-established dimension in the moving direction (A) of the workpiece (P) and in a transverse direction to said moving direction (A) of the workpiece (P) and further having a pre-established vertical extension between two horizontal levels, that include a minimum lower level and a maximum upper level,
wherein, between vertical side walls delimiting said space volume inside said working station (2) and corresponding virtual limits of the working area of said working tool (8, 108), there is provided a moving corridor for said second gripper (6) of said workpiece (P), said moving corridor providing a noninterference zone between said second gripper (6) and said working tool (8, 108), said second gripper (6) and said working tool (8, 108) being freely movable within the respective working area and moving corridor.

3. The machining center according to claim 2, wherein said working tool and the moving corridor of said second gripper (6) within the working station (2) are positioned relative to each other according to an intended working position of said working tool (8, 108) and/or an intended working position of said second gripper (6), safety limits being provided defined by a distance and/or a minimum possible size respectively between said working tool (8, 108) and said second gripper (6), and/or a relative position of said working area of said working tool (8, 108) and the moving corridor of said second gripper (6).

4. The machining center according to claim 1, wherein the working tool (8, 108) is supported by a motorized moving member (7) according to at least two degrees of freedom of said working tool, said second gripper (6) comprising motorized gripping members (206, 306) and being supported by a moving member (5, 106) thereof enabling displacement of said second gripper (6), said moving member (5, 106) being controlled by a control logic unit comprising a central processing unit executing a control program which comprises instructions for synchronized displacement and activation and deactivation of said working tool (8, 108) and of said second gripper (6) and configured to set relative dimensions and positions between said working area of said working tool (8, 108) and said moving corridor of said second gripper (6).

5. The machining center according to claim 1, wherein said second gripper (6) is mounted on a motorized slide (106), which is slidable on a guideway (5) oriented parallel to the moving direction (A) of the workpiece (P) and is translatable in a direction concordant or discordant with the moving direction of the workpiece (P).

6. The machining center according to claim 4, wherein the motorized moving member (7) of said working tool (8, 108) comprises a combination of guideways and associated slides or carriages and driving motors, wherein there are at least two guideways with corresponding slides or carriages that are oriented in one of two spatial directions, including a direction transverse to the moving direction (A) of the workpiece (P) to be machined and a vertical direction.

7. The machining center according to claim 4, wherein the first gripper (4) associated with the loading way (1) of the workpiece comprises a gripper having a plurality of jaws (204, 304) which are approachable and separable between an open position, in which the workpiece is free to move relative to said gripper, and a closed position, in which said plurality of jaws (204, 304) clamp opposing sides of the workpiece (P) being processed by holding the workpiece fixedly between said plurality of jaws, and wherein said plurality of jaws (204, 304) have front extensions (604) and/or are parallel to the moving direction (A) of the workpiece (P) towards the working station (2), said front extensions (604) extending towards an area of the inlet (20) of the working station (2), beyond a position of an end stop of maximum approach of said gripper (4) to the inlet (20) of the working station (2) for the workpiece (P) being processed or a part thereof.

8. The machining center according to claim 1, wherein, at said inlet (20) the working station (2) has a first pair (22) of rollers (122, 222) for gripping the workpiece (P) to be machined at the inlet to said working station (2), the rollers (122, 222) of the at least one pair (22) being rotatable about axes which are parallel to each other, said rollers or at least one of said rollers (222) being displaceable transversally to a rotation axis in a direction of reciprocal approach and of distancing to and from a side of the workpiece (P) facing one of the two rollers (122, 222).

9. The machining center according to claim 8, wherein said first pair (22) of rollers is provided in combination with and adjacent to a second pair (23) of rollers (123, 223), which are rotatable about axes parallel to each other and mounted displaceable in a direction of reciprocal approach and of distancing to and from the side facing a respective roller of the second pair, axes of said second pair (23) of rollers being oriented according to a different direction with respect to the axes of said first pair (22) of rollers, a direction of approach and departure of the rollers (122, 222) of said first pair (22) of rollers being different from the direction of reciprocal approach and departure of said first pair (22) of rollers.

10. The machining center according to claim 9, wherein in combination with said first pair of rollers and/or said first and said second pair (22, 23) of rollers, the front extensions (604) of the jaws (204, 304) of said first gripper (4), terminate in correspondence with or in a position adjacent to a plane of displacement of the axes of said first pair (22) of rollers or flush with an innermost side of the working station of said rollers (122, 222), when said gripper (4) is in a position of maximum end-stroke to the inlet (20) of said working station (2).

11. The machining center according to one claim 9, wherein one (123) of the rollers of the second pair (23) of rollers is stationary and extends with an external surface flush with a workpiece (P) support surface of the loading way (1).

12. The machining center according to claim 11,
wherein one of the rollers (122) of the first pair (22) of rollers is stationary and operates as a workpiece (P) reference stop position, providing a zero reference, the rollers (122, 222) of the first pair having an axial extension which is greater than a corresponding maximum dimension of the workpiece (P) being machined,
wherein the axial extension is greater than a corresponding maximum dimension of the workpiece (P) being machined and corresponds to a sum of dimensions in a direction of the front extensions (604) of the jaws (204, 304) and/or of at least part of a stroke in a direction of reciprocal displacement of said jaws (204, 304), and
wherein in a position of maximum approach of the loading gripper (4) to the inlet (20) of the working station (2), said front extensions (604) of the jaws (204, 304) of the loading gripper (4) overlap with a side of the roller (122) that is stationary on the side facing an opposing roller (222) of said first pair (22) of rollers, at least for part of a diameter of said roller (122) that is stationary or for an entire diameter of said roller (122) that is stationary in the moving direction (A) of the workpiece (P).

13. The machining center according to one claim 9,
wherein the second gripper (6) inside the working station is a gripper which is slidable in two directions between the inlet (20) and the outlet (21) of the working station (2) along a guide (5) oriented in the moving direction (A) of the workpiece (P), as an extension in said moving direction (A) of the workpiece (P) or provided as one piece with a traversing guide of the first gripper associated with the loading way (1), and
wherein, in a position of maximum approach to the inlet (20) of the working station (2) said second gripper (6) is adjacent to facing ends of the front extensions (604) of the jaws (204, 304) of the loading gripper (4), providing an extension thereof in the moving direction (A) of the workpiece (P) within the working station (2).

14. The machining center according to claim 11, wherein on the outlet (21) of the working station the second gripper (6) is positioned adjacent to a pair of motorized grippers of the workpiece (P) to be machined, which are actuated for extracting the workpiece (P) from the working station (2) when the second gripper (6) has been brought into a state of release of the workpiece (P).

15. The machining center according to one claim 14, wherein the stationary roller (122) of the first pair (22) of rollers, at the inlet (20) of the working station (2) is associated, in a spaced position toward the loading way (1), with at least one further stationary roller (422), which is aligned with the stationary roller (122) of the first pair (22) of rollers relative to the feed direction (A) of the workpiece (P) towards the working station (2), the at least one further stationary roller (422) being rotatable about an axis parallel to an axis of the rollers (122, 222) of said first pair (22) of rollers, and having a diameter identical to said stationary roller (122) of said first pair (22) of rollers, thereby generating two support points which are spaced apart from each other in the moving direction (A) of said workpiece (P) and which define a reference position of said workpiece (P) relative to a direction perpendicular to the moving direction (A) of said workpiece (P) and parallel to the support plane of said workpiece (P) on the loading way (1) and on the one of the rollers (123) of said second pair (23) of rollers.

16. The machining center according to claim 4, wherein the control logic unit of the working station (2) executes a control program which comprises instructions for said logic unit to control a process of manipulating the workpiece (P) with the two grippers (4, 6) according to the following steps:
the first gripper (4) associated with the loading way (1) grips the workpiece (P) being processed by moving to the position of maximum approach to the inlet (20) of the working station (2);
in the position of maximum approach, the first gripper (4) finds the second gripper (6) inside the working station (2), the second gripper having been brought to a position adjacent to the inlet (20) of the working station (2) and to ends of the extensions (604) of the jaws (204, 304) of the first loading gripper (4);
the second gripper (6) clamps the workpiece (P) being machined, leaving an initial section projecting forward with respect to the gripper, and the first gripper (4) opens by releasing the workpiece while the second gripper (6) moves relative to the working tool (8, 108) to the right and/or left of the working tool to perform a machining operation that defines a reference relative to a longitudinal extension of the workpiece;
at least the second gripper (6) or the first and the second grippers (4, 6) remain active or are activated to clamp the workpiece (P) to be machined after a zero cut and the second gripper (6) with the workpiece clamped therein move in a direction where the workpiece moves until the second gripper (6) has passed beyond a working range of the tool (8, 108) of the workpiece (P) and at a further predefined machining zone of the workpiece (P); and
at least the second gripper (6) moves further towards the outlet (21) of the working station (2) with the workpiece (P) clamped therein until the workpiece is gripped by the unloading grippers which pick up the workpiece (P) and deposit the workpiece on the unloading way (3) after the second gripper (6) has changed to an open condition and released the workpiece (P).
